(19) United States
(12) Patent Application Publication
(10) Pub. No.: US 2018/0373688 A1
(43) Pub. Date: Dec. 27, 2018

(54) SHARING ANNOTATIONS TO WEB PAGES

(71) Applicant: Microsoft Technology Licensing, LLC, Redmond, WA (US)

(72) Inventor: Kaustav MUKHERJEE, Hyderabad (IN)

(21) Appl. No.: 15/635,192

(22) Filed: Jun. 27, 2017

(51) Int. Cl. G06F 17/24; G06F 17/22

(52) U.S. Cl. CPC G06F 17/241; H04L 67/146; G06F 17/2235; G06F 17/2288

(57) ABSTRACT

A facility supporting the sharing of annotated web pages is described. The facility enables a user to specify annotations—such as highlighting annotations—each with respect to a portion of a subject web page. In response, the facility creates and stores a copy of the tag language representation of the subject web page in which custom tags represent the specified annotations. The facility also provides a special URL that can be shared with other users by the annotating user, and can be used by any of those other users to retrieve and display the stored tag language representation to view the annotations.

### BACKGROUND

Browsers are applications that display web pages. Often, when a user views a web page, she finds particular content in the web page to which she wants to draw a friend's attention. For example, she may send a friend an email message that contains a URL identifying a web page describing the careers of standout bowlers, and a recommendation to scroll down in the web page to read about Earl Anthony's amazing accomplishments.

### SUMMARY

This summary is provided to introduce a selection of concepts in a simplified form that are further described below in the Detailed Description. This summary is not intended to identify key factors or essential features of the claimed subject matter, nor is it intended to be used to limit the scope of the claimed subject matter.

A facility supporting the sharing of annotated web pages is described. The facility enables a user to specify annotations—such as highlighting annotations—each with respect to a portion of a subject web page. In response, the facility creates and stores a copy of the tag language representation of the subject web page in which custom tags represent the specified annotations. The facility also provides a special URL that can be shared with other users by the annotating user, and can be used by any of those other users to retrieve and display the stored tag language representation to view the annotations.

### BRIEF DESCRIPTION OF THE DRAWINGS

FIG. 1 is a network diagram showing an environment in which the facility operates in some examples.

FIG. 2 is a block diagram showing some of the components typically incorporated in at least some of the computer systems and other devices on which the facility operates.

FIG. 3 is flow diagram showing a process performed by the facility in a web browser.

FIG. 4 is a display diagram showing a sample display presented by the facility in some examples to present a sample web page for initial highlighting by a first user.

FIG. 5 is a display diagram showing a sample display presented by the facility in some examples when the first user selects content in the sample web page.

FIG. 6 is a display diagram showing a sample display presented by the facility in some examples to reflect the highlighting of a first portion of the web page by the first user.

FIG. 7 is a flow diagram showing a process performed by the facility in some examples in an annotation server to process and upload request sent by a web browser.

FIG. 8 is a table diagram showing sample contents of an annotation table maintained by the facility in some examples to store annotated copies of web pages.

FIG. 9 is a display diagram showing sample contents of a display presented by the facility in some examples to display the ATTP URL assigned to the first user's annotations.

FIG. 10 is a flow diagram showing a process performed by the facility in some examples in the annotation server to process an annotation retrieval request received from a web browser.

FIG. 11 is a display diagram showing a sample display presented by the facility in some examples to a second user who has accessed the first user's annotations.

FIG. 12 is a display diagram showing a sample display presented by the facility in some embodiments showing the second user's interactions with the annotated web page.

FIG. 13 is a display diagram showing a sample display presented by the facility in some examples to reflect the user's creation of a highlighting annotation.

FIG. 14 is a table diagram same contents of the annotation table updated to reflect the upload request from a second user's web browser.

FIG. 15 is a display diagram showing a sample display presented by the facility in some examples to reflect storage of the second user's annotations.

FIG. 16 is a display diagram showing a sample display presented by the facility in some examples when a third user references the second ATTP URL.

### DETAILED DESCRIPTION

The inventors have identified important disadvantages in how users conventionally recommend portions of web pages to others. In particular, the inventors have noted that, if a first user emails the page's URL to a second user as described above, the following disadvantages befall the second user: (1) The second user must manually identify the portion of the document referred to by the first user. (2) The first user may not have included enough information about the referenced portion of the web page—the second user may be left wondering, for example, whether the first user was impressed by Mr. Anthony being the first pro bowler to win more than $1,000,000, or his 1981 induction into the Professional Bowlers Association Hall of Fame. (3) Between the times that the first and second user view the page, the page may have changed in a way that alters or deletes the referenced portion, preventing the second user from being able to obtain the referenced content.

The inventors have identified conventional alternatives to the URL-emailing approach, but these have their own significant disadvantages. In particular, certain browsers or browser add-ons make it possible for the first user to capture an image of the web page in its present state, and annotate that image, such as by highlighting contents, or handwriting on or near them. While this approach addresses many of the problems of the URL-emailing approach, it creates its own: this annotated image of a web page doesn't function as a web page. Links and controls of other types in the web page are inactive, text can't be selected for copying onto the clipboard for launching a search engine query, etc.

In response to this recognition, the inventors have conceived and reduced to practice a software and/or hardware facility for sharing annotated web pages in a way that maintains their character as web pages (“the facility”).

In some examples, the facility adds annotation controls to a web browser, such as controls that users of the web browser can use to highlight text spans within any web page. (While this application mainly discusses text highlighting annotations, those skilled in the art will appreciate that, in various examples, the facility manages the creation and sharing of a variety of kinds of annotations to web pages.) The facility stores a copy of the web page on a server, after adding tags to effect the highlighting. The facility provides a special URL to the “first,” highlighting user that the first user can use to share the highlighted version of the web page with other users. In some examples, in the URL field of the first user's browser, the facility replaces the original URL of the web page with the special URL generated by the facility for the annotated copy of the web page. When a second user dereferences the special URL, the second user's web browser retrieves and displays the annotated copy of the page, such that the first user's highlighting appears to the second user.

The contents of the version of the web page displayed to the second user exactly match its contents when the first user performed the highlighting, irrespective of any changes to the original web page between the highlighting by the first user and the display by the second user. Indeed, the original web page could have been deleted in the interim, and the second user will still see the version of the web page that was highlighted by the first user. While the highlighted version of the web page is displayed by the second user, it is active in the same ways as it was originally to the first user: links can be followed, text can be selected, embedded audio and video can be played, etc.

In some examples, the web page is displayed to the second user together with a “table of annotations”: a list of the instances of highlighting contained by the web page, which permits the second user to click on one of the instances and jump to the portion of the web page containing the associated highlighting. In some examples, each item in the table of annotations is a thumbnail of the highlighted text.

In some examples, the second user can proceed to add his or her own highlighting to the web page previously highlighted by the first user. In response, the facility stores a second copy of the web page, to which it has added tags incorporating the second user's highlighting, such that the second copy of the web page contains tags incorporating both the first and the second users' highlighting. The facility provides to the second user a second special URL that any user may use to access the stored version of the web page containing the first and second users' highlighting. In some examples, further versions of the web page incorporating additional annotations can be produced indefinitely, by any number of users. In some examples, the special URLs that refer to these annotated versions of the web page include an explicit version number, which can be varied by a dereferencing user to select which of the stored versions of the web page is retrieved when the special URL is dereferenced.

In some examples, the facility generates the special URLs that refer to the annotated pages using a new URL scheme different from the “HTTP:” URL scheme, such as an “ATTP:” URL scheme. This web scheme directs a web browser to send a page retrieval request to a special annotation server, enclosing the URL. When the annotation server receives such a request, it returns the augmented web page corresponding to an identifier included in the URL, such as a globally-unique identifier (“GUID”) included in the URL. In some examples, the URL also includes at least part of the original URL of the web page, such as its domain, or everything after the “HTTP:” web scheme of the original URL.

By performing in some or all of the ways described above, the facility enables users to easily highlight or otherwise annotate web pages, and share the web pages with these annotations with other users.

Also, by performing in some or all of the ways described, the facility meaningfully reduces the hardware resources needed to share annotations to web pages, including, for example: reducing the amount of storage space needed to store related information; and reducing the number of processing cycles needed to perform this process. This allows programs making use of the facility to execute on computer systems that have less storage and processing capacity, occupy less physical space, consume less energy, produce less heat, and are less expensive to acquire and operate. Also, such a computer system can perform annotation sharing with less latency, producing a better user experience and allowing users to do a particular amount of work in less time.

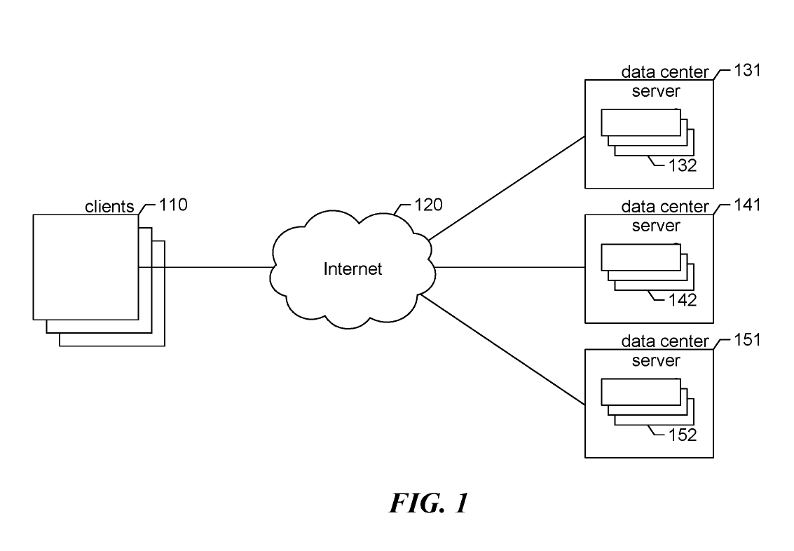

FIG. 1 is a network diagram showing an environment in which the facility operates in some examples. The network diagram shows clients 110 each typically being used by different user. Each of the clients execute software enabling its user to interact with documents, such as a browser enabling its user to interact with web page documents. The clients are connected by the Internet 120 and/or one or more other networks to data centers such as data centers 131, 141, and 151, which in some examples are distributed geographically to provide disaster and outage survivability, both in terms of data integrity and in terms of continuous availability. Distributing the data centers geographically also helps to minimize communications latency with clients in various geographic locations. Each of the data centers contain servers, such as servers 132, 142, and 152. Each server can perform one or more of the following: serving web pages, and storing annotated versions of web pages.

While various examples of the facility are described in terms of the environment outlined above, those skilled in the art will appreciate that the facility may be implemented in a variety of other environments including a single, monolithic computer system, as well as various other combinations of computer systems or similar devices connected in various ways. In various examples, a variety of computing systems or other different devices are used as clients, including desktop computer systems, laptop computer systems, automobile computer systems, tablet computer systems, smart phones, personal digital assistants, televisions, cameras, etc.

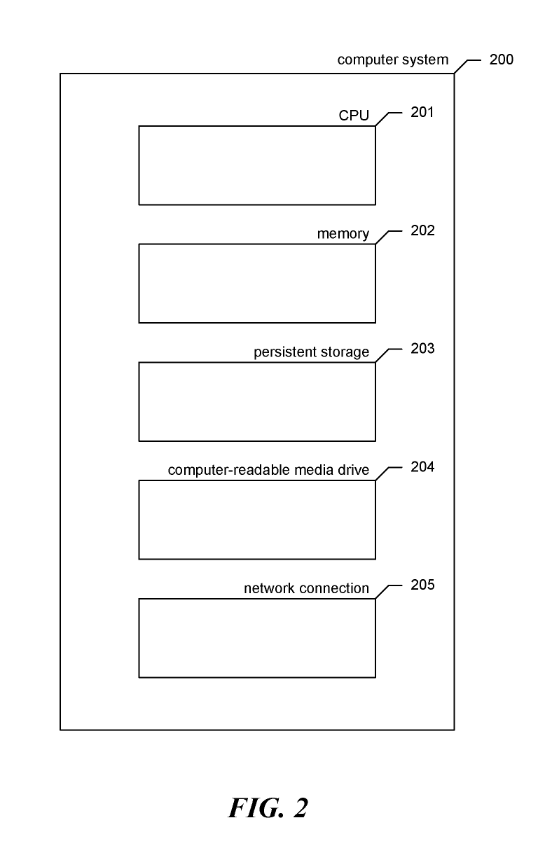

FIG. 2 is a block diagram showing some of the components typically incorporated in at least some of the computer systems and other devices on which the facility operates. In various examples, these computer systems and other devices 200 can include server computer systems, desktop computer systems, laptop computer systems, netbooks, mobile phones, personal digital assistants, televisions, cameras, automobile computers, electronic media players, etc. In various examples, the computer systems and devices include zero or more of each of the following: a central processing unit (“CPU”) 201 for executing computer programs; a computer memory 202 for storing programs and data while they are being used, including the facility and associated data, an operating system including a kernel, and device drivers; a persistent storage device 203, such as a hard drive or flash drive for persistently storing programs and data; a computer-readable media drive 204, such as a floppy, CD-ROM, or DVD drive, for reading programs and data stored on a computer-readable medium; and a network connection 205 for connecting the computer system to other computer systems to send and/or receive data, such as via the Internet or another network and its networking hardware, such as switches, rootrs, repeaters, electrical cables and optical fibers, light emitters and receivers, radio transmitters and receivers, and the like. While computer systems con Figured as described above are typically used to support the operation of the facility, those skilled in the art will appreciate that the facility may be implemented using devices of various types and configurations, and having various components.

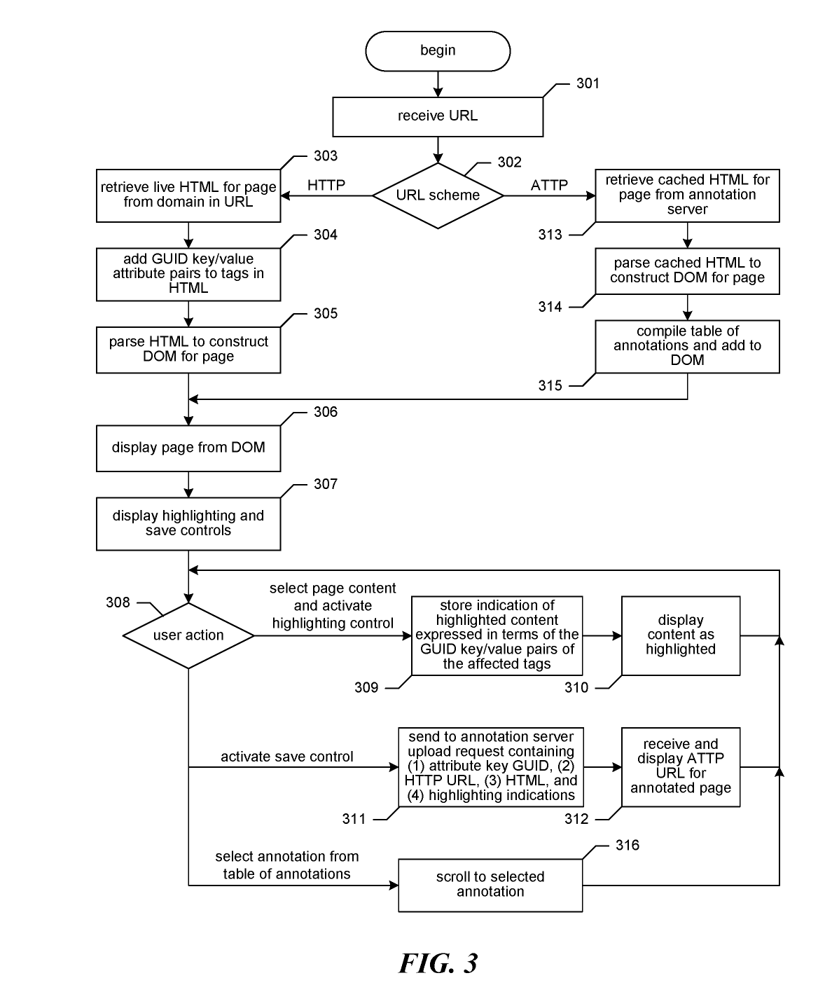

FIG. 3 is flow diagram showing a process performed by the facility in a web browser. At 301, the facility receives a URL. In various examples, the facility receives the URL when the URL is typed in a URL field; when a link encoding the URL is followed; when a bookmark or browsing history reference encoding the URL is dereferenced, etc. At 302, if the URL scheme of the URL received at 301 is “HTTP,” then the facility continues at 303; if the URL scheme is “ATTP,” then the facility continues at 313.

At 303, the facility uses an HTTP request to retrieve the HTML web page source for the page that is the subject of the URL from the Internet domain included in the URL. A section of the live HTML for a sample page retrieved by the facility at 303 is shown below in Table 1.

TABLE 1

| | |
|---|---|
| 1 | . . . |
| 2 | <div class = ″a_class″ id = ″an_id″>First PBA bowler to reach $1M in lifetime earnings |
| 3 | - 1982</div> |
| 4 | <a href=http://www.bowlingstars.com/stats/anthony_poty.htm>Six-time PBA Player of the |
| 5 | Year</a> |
| 6 | <div class = ″a_class″ id = ″an_id″>First PBA bowler to reach $1M in lifetime earnings |
| 7 | - 1982</div> |
| 8 | . . . |

It can be seen that lines 2-3 and 6-7 of Table 1 each contain a <div> tag specifying text to be displayed in the web page. Further, lines 4-5 of Table 1 contain an <a> tag specifying a link to a related web page, as well as associated text.

At 304, the facility adds to some or all of the tags in the HTML retrieved at 303 GUID key/value attribute pairs. In some examples, the GUIDs used by the facility are large numbers or a long alphabetic or alphanumeric strings selected at random in a way that ensures that they are reasonably unique. In particular, the facility generates a single GUID corresponding to the user's retrieval of the entire web page, and an additional GUID for each altered HTML tag to uniquely identify it in the web page. Table 2 below shows the addition at 304 performed with respect to the HTML shown in Table 1.

TABLE 2

| | |
|---|---|
| 1 | . . . |
| 2 | <div 4560-2932-4457-2295 = ″4568-7489-1223-5321″ class = ″a_class″ id = ″an_id″>First |
| 3 | PBA bowler to reach $1M in lifetime earnings - 1982</div> |
| 4 | <a href=http://www.bowlingstars.com/stats/anthony_poty.htm>Six-time PBA Player of the |
| 5 | Year</a> |
| 6 | <div 4560-2932-4457-2295 = ″5711-8612-6754-3541″ class = ″a_class″ id = ″an_id″>First |
| 7 | PBA bowler to reach $1M in lifetime earnings - 1982</div> |
| 8 | . . . |

It can be seen that the facility has added a GUID key/value attribute pair to each of the <div> tags shown in lines 2-3 and 6-7. In each of these added key/value attribute pairs, the key/value is the same GUID, which identifies the user's retrieval of the web page: 4560-2932-4457-2295. It can further be seen that the two <div> tags have different attribute value GUIDs, such that the value 4568-7489-1223-5321 uniquely identifies the <div> tag shown in lines 2-3, while the 5711-8612-6754-3541 value identifies the <div> tag shown in lines 6-7.

At 305, the facility parses the HTML to construct a Document Object Model (“DOM”) for the web page, in a manner conventionally used by web browsers. At 306, the facility uses the DOM constructed at 305 to display the web page. At 307, the facility displays controls for adding highlighting annotations to the web page and saving these highlighting annotations.

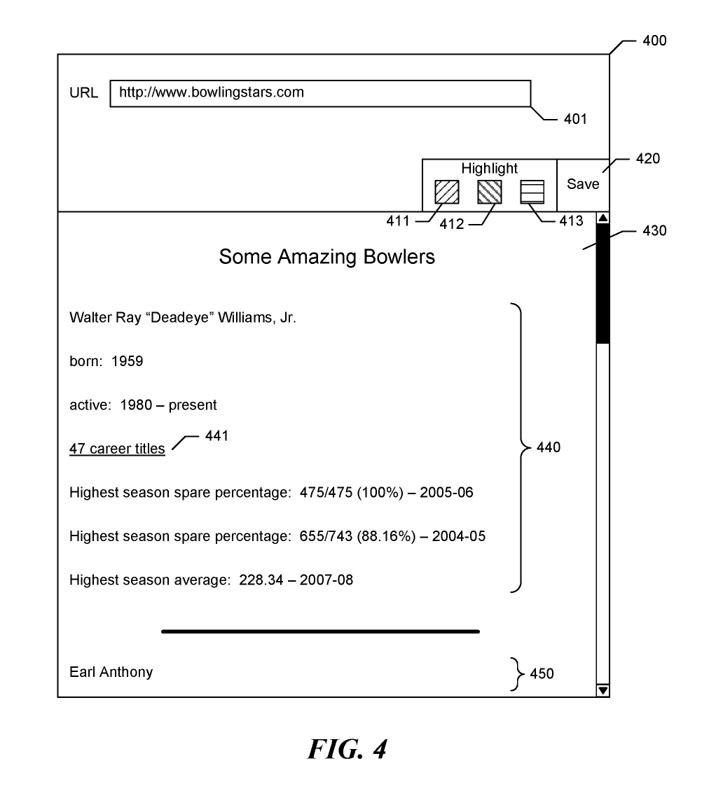

FIG. 4 is a display diagram showing a sample display presented by the facility in some examples to present a sample web page for initial highlighting by a first user. The display includes a browser window 400, which has a URL field 401; highlighting controls 411-413; and a save control 420. The browser window further has a client area 430 in which the contents of the web page are displayed. The contents of the web page shown in FIG. 4 include a section 440 about a first bowler, which includes a link 441 to a related website. Also in FIG. 4, the beginning of another section 450 of the web page relating to a second bowler is shown. The web page contents can be scrolled in the client area, such as by using a scroll bar shown on the right-hand side of the client area.

At 308, the facility branches on a user action performed with respect to the browser: if the action is to select content in the web page and activate a highlighting control, then the facility continues at 309; if the action is to activate the save control, then the facility continues at 311; and if the action is to select annotations from a table of annotations displayed by the browser, then the facility continues at 316.

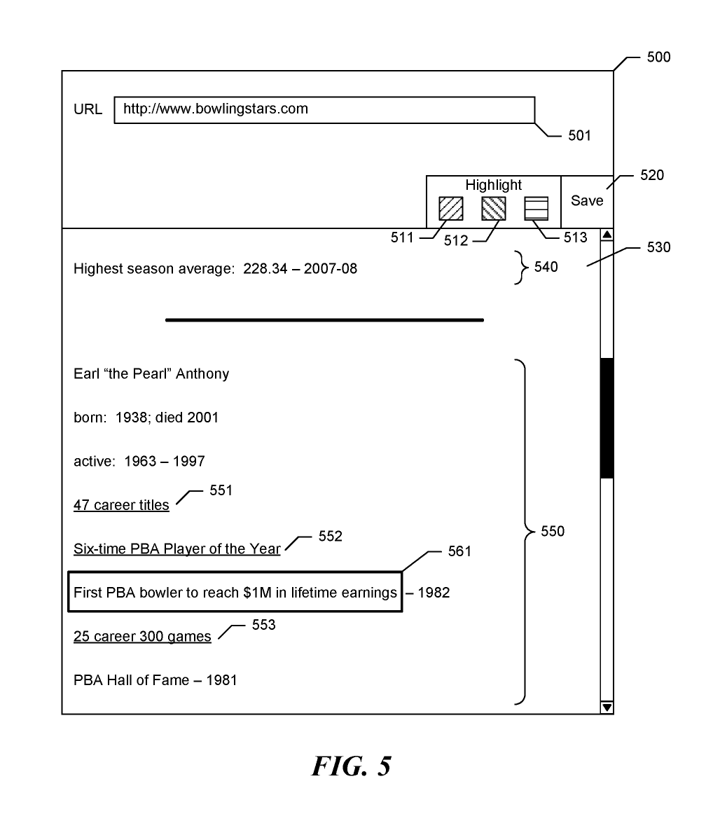

FIG. 5 is a display diagram showing a sample display presented by the facility in some examples when the first user selects content in the sample web page. Comparing FIG. 5 to FIG. 4, it can be seen that the user has scrolled down to display contents of the web page in client area 530 that are lower in the web page than those displayed in FIG. 4. In particular, the entire section 550 relating to the second bowler, Earl Anthony, is displayed. This section includes three links 551-553 to related web pages. In section 550, the user has selected text 561, such as by holding down the mouse button while dragging a mouse cursor across this text, swiping a finger or stylus across this text, drawing a box around this text, speaking this text, etc. After selecting text 561, the user activates highlight control 512 to highlight text 561.

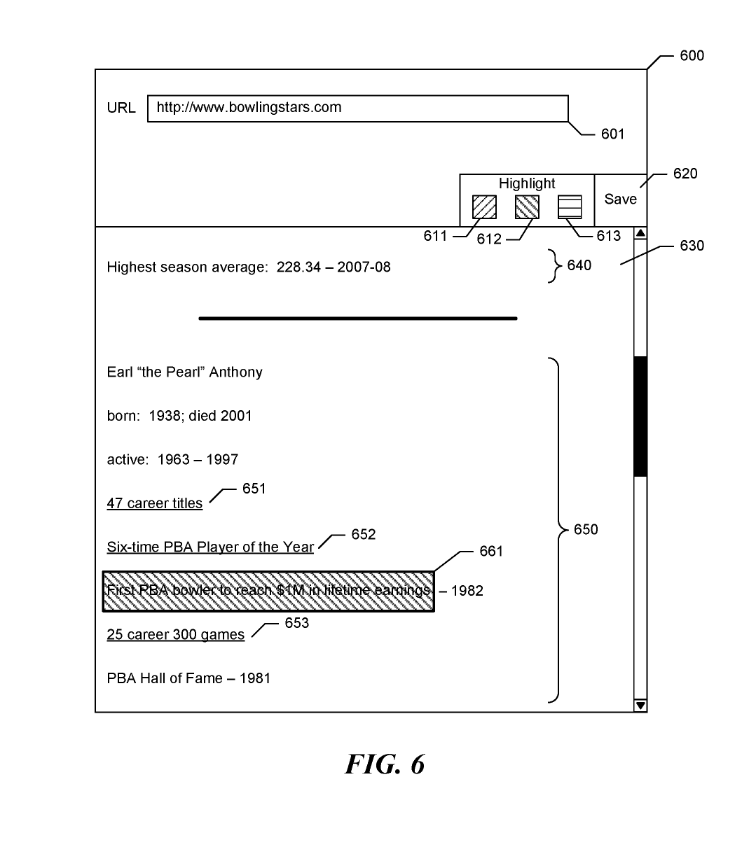

Returning to FIG. 3, at 309, when the user has selected page content and activated a highlighting control, the facility stores an indication of the highlighted content that is expressed in terms of the GUID key/value pairs of the HTML tags that are affected by the content selection in highlighting. Table 3 below shows sample JSON indication of the highlighting shown in FIG. 6.

TABLE 3

| | |
|---|---|
| 1 | . . . |
| 2 | { |
| 3 | ″4560-2932-4457-2295″: ″4568-7489-1223-5321″, |
| 4 | ″offsets″: [ |
| 5 | { |
| 6 | ″range:″ [1,50], |
| 7 | ″color″: ″red″ |
| 8 | }, |
| 9 | ] |
| 10 | } |
| 11 | . . . |

It can be seen that the highlighted content indication identifies the <div> tag shown in lines 2-3 of Table 2 by its reference in line 3 to the same GUID key/value pair. Table 3 further contains, in an “offsets” attribute, a range in the text attached to this <div> tag that is subject to the highlighting, namely from the first character to the fiftieth character of this text in line 6. Also, line 7 indicates the color “red,” corresponding to the color selected—by choosing highlighting control 612.

At 310, the facility displays the content as highlighted by the user input. After 310, the facility continues at 308 to process the next user action.

FIG. 6 is a display diagram showing a sample display presented by the facility in some examples to reflect the highlighting of a first portion of the web page by the first user. It can be seen by comparing FIG. 6 to FIG. 5 that, by activating highlighting control 512, the facility has highlighted text 661 with the same pattern and/or color as shown in highlighting control 512/612. After doing so, the user can activate save control 620 in order to make a copy of this web page containing this highlighting available to share.

Returning to FIG. 3, at 311, when the user has activated the save control, the facility sends to the annotation server an annotation upload request containing the following information: the attribute key GUID, here 4560-2932-4457-2295; the HTTP URL used at 303 to retrieve the web page; the HTML, as augmented at 304; and all highlighting indications stored at 309.

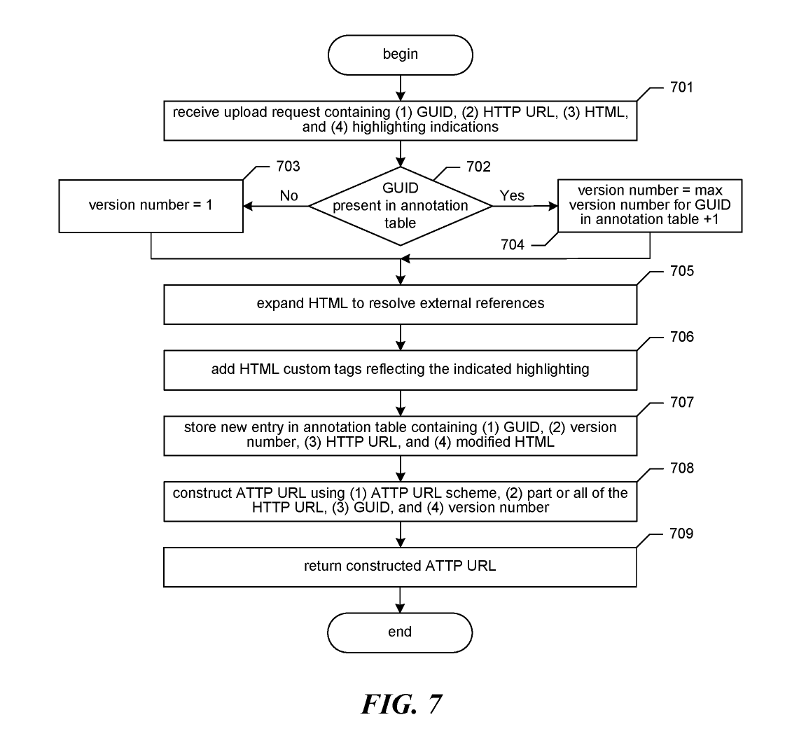

FIG. 7 is a flow diagram showing a process performed by the facility in some examples in an annotation server to process and upload request sent by a web browser. At 701, the facility receives an upload request that contains a GUID assigned to identify an instance of retrieving a web page, an HTTP URL used originally to retrieve the web page, HTML for the web page that has been augmented with GUID key/value attribute pairs in some of its tags, and highlighting indications. At 702, the facility determines whether the GUID contained by the upload request received at 701 is present in an annotation table used to store annotated copies of web pages; if it is, the facility continues at 704 to choose a version number for the upload request that is one greater than the largest version number for this GUID in the annotation table, else the facility continues at 703 to select a version number 1. At 705, the facility expands the received HTML to resolve any external references contained by the HTML. For example, the HTML may include external references to style sheets or other style resources, javascript scripts, media artifacts such as audio, video, or Flash sequences, etc. Table 4 below shows a portion of HTML for the sample page that includes external references resolved by the facility at 705.

TABLE 4

| | |
|---|---|
| 1 | . . . |
| 2 | <link rel=″stylesheet″type=″text/css href=″../theme.css″> |
| 3 | <script src=″myscripts.js″></script> |
| 4 | . . . |

Line 2 of Table 4 contains an external reference to a CSS style sheet incorporated by reference into the HTML of the web page. The facility resolves this external reference at 805 by retrieving the referenced “theme.css” file, and replacing line 2 in Table 4 within the HTML file with the retrieved contents of the CSS style sheet. The facility performs similarly to resolve the external script reference shown in line 3 of Table 4.

At 706, the facility adds custom HTML tags to reflect the highlighting indicated by the highlighting indications received in the upload request. Table 5 below shows an example of the addition of these custom tags at 706.

TABLE 5

| | |
|---|---|
| 1 | . . . |
| 2 | <div 4560-2932-4457-2295 = ″4568-7489-1223-5321″ class = ″a_class″ id = ″an_id″><4564- |
| 3 | 8482-4564-6546 style = ′background:red;′>First PBA bowler to reach $1M in lifetime |
| 4 | earnings</4564-8482-4564-6546> - 1982</div> |
| 5 | <a href=http://www.bowlingstars.com/stats/anthony_poty.htm>Six-time PBA Player of the |
| 6 | Year</a> |
| 7 | <div 4560-2932-4457-2295 = ″5711-8612-6754-3541″ class = ″a_class″ id = ″an_id″>First |
| 8 | PBA bowler to reach $1M in lifetime earnings - 1982</div> |
| 9 | . . . |

By comparing Table 5 to Table 2, it can be seen that the facility has added a custom tag to the <div> tag shown in lines 2-3 of Table 2, resulting in lines 2-4 of Table 5. In particular, the custom tag, which begins near the end of line 1 of Table 5, has a name corresponding to a newly-generated GUID (40564-8482-4564-6546) and specifies an in-line style that has only one rule: Background Color (red). The tag spans the first 50 characters of the text enclosed by the <div> tag, which corresponds to the text selected by the user in FIG. 5.

At 707, the facility stores a new entry in the annotation table that contains the GUID received in the upload request, the annotation version number determined at 703 or 704, the HTTP URL contain an receive upload request, and the received HTML for the web page as further modified at 805-806.

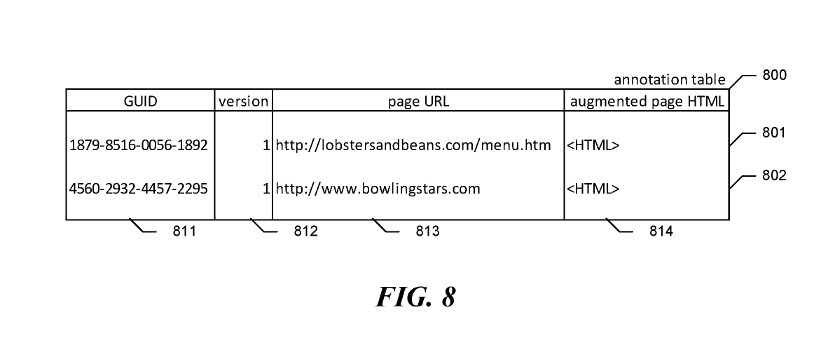

FIG. 8 is a table diagram showing sample contents of an annotation table maintained by the facility in some examples to store annotated copies of web pages. The annotation table 800 is made up of rows, such as rows 801-802, each corresponding to a different version of a web page that has been annotated and stored using the facility. Each row is divided into the following columns: a GUID column 811, which contains a GUID identifying the original retrieval of the web page on which one or more rounds of annotation are based; a version column 812, containing the version of annotations to which the row corresponds; a page URL column 813, containing the HTTP URL used to originally retrieve the page for the first round of annotations; and an augmented page HTML column 814, containing the HTML for the page as augmented at 304 shown in FIG. 3 and at 705-706 shown in FIG. 7. For example, row 802 indicates that the web page at “http://www.bowlingstars.com,” whose initial retrieval for annotation is identified by GUID 4560-2932-4457-2295, has a first annotation version, represented by augmented page HTML contained at the intersection of row 802 with column 814 (not shown), which includes the modifications shown in and discussed in connection with Tables 2, 4 and 5.

While FIG. 8 and each of the table diagrams discussed below show a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed and/or encrypted; may contain a much larger number of rows than shown, etc.

Returning to FIG. 7, at 708, the facility constructs an ATTP URL to represent the annotation version stored at 707. This ATTP URL contains the HTTP URL scheme at the beginning; at least the domain from the original HTTP URL for the web page; the GUID stored in the new annotation table entry, and the annotation version number stored in the new annotation table entry. For the example discussed herein, the facility constructs the ATTP URL “attp://www.bowlingstars.com:4560-2932-4457-2295.” In this case, the version number, 1, is implied. At 709, the facility returns the ATTP URL constructed at 708 to the web browser from which the upload request was received at 701. After 709, this process concludes.

Those skilled in the art will appreciate that the acts shown in FIG. 7 and in each of the flow diagrams discussed herein may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

Returning to FIG. 3, at 312, the facility receives the ATTP URL returned by the annotation server and displays it. In various examples, the facility displays the ATTP URL in a pop-up window or other message, and/or in the URL field of the browser. After 312, the facility continues at 308 to process the next user action.

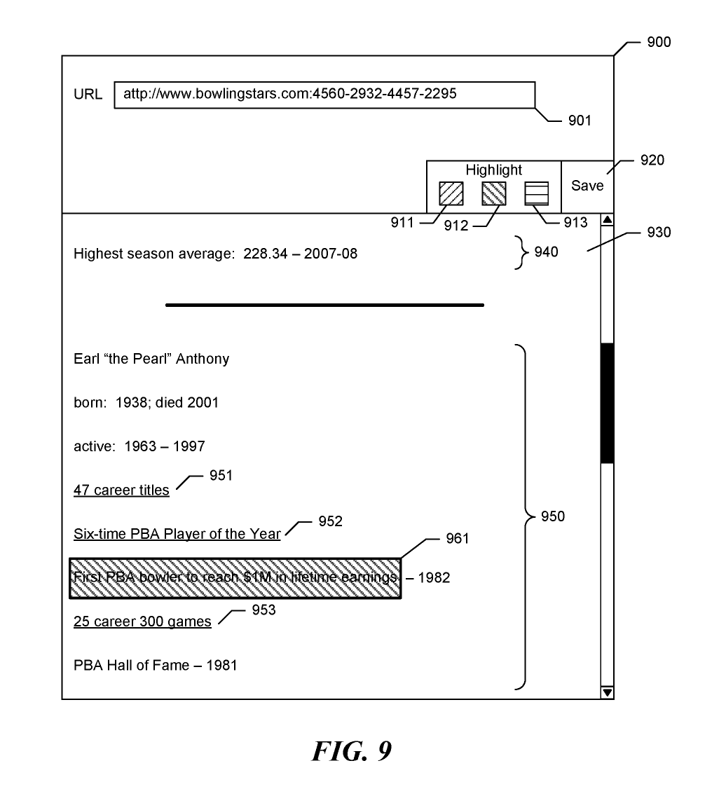

FIG. 9 is a display diagram showing sample contents of a display presented by the facility in some examples to display the ATTP URL assigned to the first user's annotations. By comparing FIG. 9 to FIG. 6, it can be seen that the facility has replaced the original HTTP URL shown in URL Field 601 with the ATTP URL received from the annotation server and URL Field 901. As discussed above, the facility may instead or in addition display the ATTP URL for the annotated page in a variety of other ways.

After the first user receives the ATTP URL identifying the first user's annotations, the first user can share these annotations with any other user by sending them the ATTP URL. Any of these other users can de-reference the ATTP URL by submitting it to a browser, such as by typing it or pasting it into a URL Field, following a link encoding the ATTP URL provided by the first user, etc. The facility processes the receipt of this ATTP URL from a second user as shown in FIG. 3: it receives the ATTP URL at 301; and, at 302, determines that the URL has the ATTP scheme, therefore proceeding to 313. At 313, the facility retrieves the cached HTML for the page from the annotation server by sending the annotation server a retrieval request.

In some examples (not shown), the facility only displays the ATTP URL in the URL field while the URL field is selected by the user, such as by clicking on the URL field, enabling the ATTP URL to be easily copied by the user for sharing with other users. At all other times, the facility displays the web page's HTTP URL in the URL field, deepening the annotated web page's connection to the original web page on which it is based. In some cases, the version of the web page's HTTP URL displayed in the URL field is simplified, such as by omitting its “HTTP:” URL scheme.

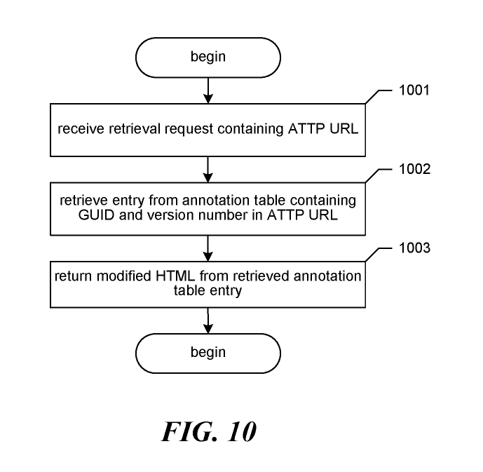

FIG. 10 is a flow diagram showing a process performed by the facility in some examples in the annotation server to process an annotation retrieval request received from a web browser. At 1001, the facility receives from a web browser a retrieval request containing an ATTP URL. At 1002, the facility retrieves an entry from the annotation table containing the GUID contained by the received ATTP URL and any version number contained in the ATTP URL. For the ATTP URL shown in the URL field 901 in FIG. 9, the facility retrieves entry 802 from the annotation table shown in FIG. 8. At 1003, the facility returns the HTML contained in the retrieved annotation table entry to the web browser from which the retrieval request was received. After 1003, this process concludes.

Returning to FIG. 3, at 314, in a manner similar to 305, the facility parses the HTML retrieved at 313 to construct a DOM for the web page. At 315, the facility compiles a table of annotations made up of links to each instance of annotation encountered in the parsed HTML as a custom tag, and adds this compiled table of annotations to the DOM constructed at 314. After 315, the facility continues at 306 to display the page from the DOM constructed at 314 and augmented at 315.

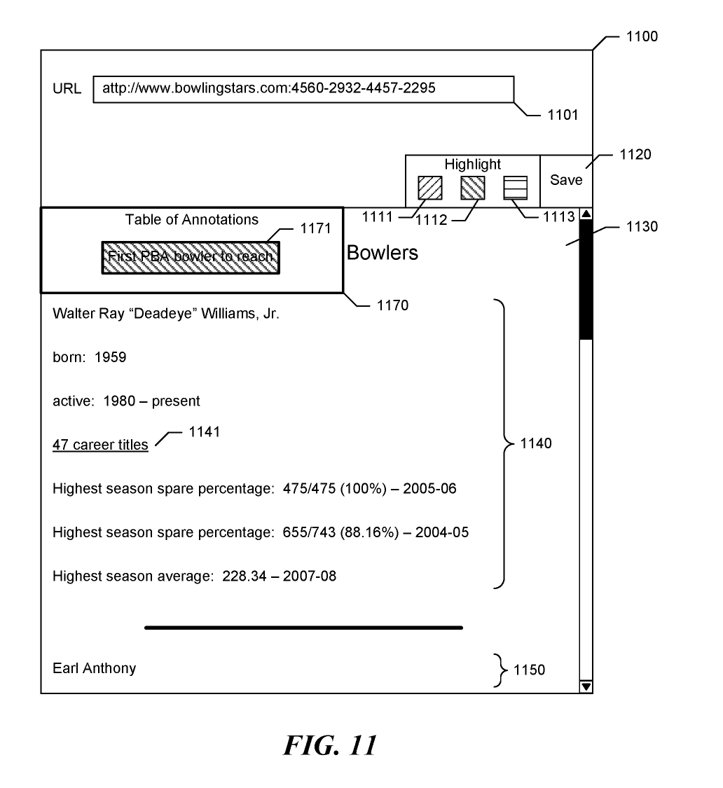

FIG. 11 is a display diagram showing a sample display presented by the facility in some examples to a second user who has accessed the first user's annotations. It can be seen that URL field 1101 contains the ATTP URL for the first user's annotations. It can further be seen that a table of annotations 1170 is displayed. The table of annotations contain a thumbnail 1171 of the first user's only highlighting annotation. The user can click on thumbnail 1171 in the table of annotations to scroll the annotated web page to a point where the thumbnailed highlighting annotation is visible in the context of the web page.

The facility also displays the highlighting and save controls at 307. At 308, when the user selects an annotation instance from the table of annotations, the facility continues at 316. At 316, the facility scrolls to the selected annotation. After 316, the facility continues at 308 to process the next user action.

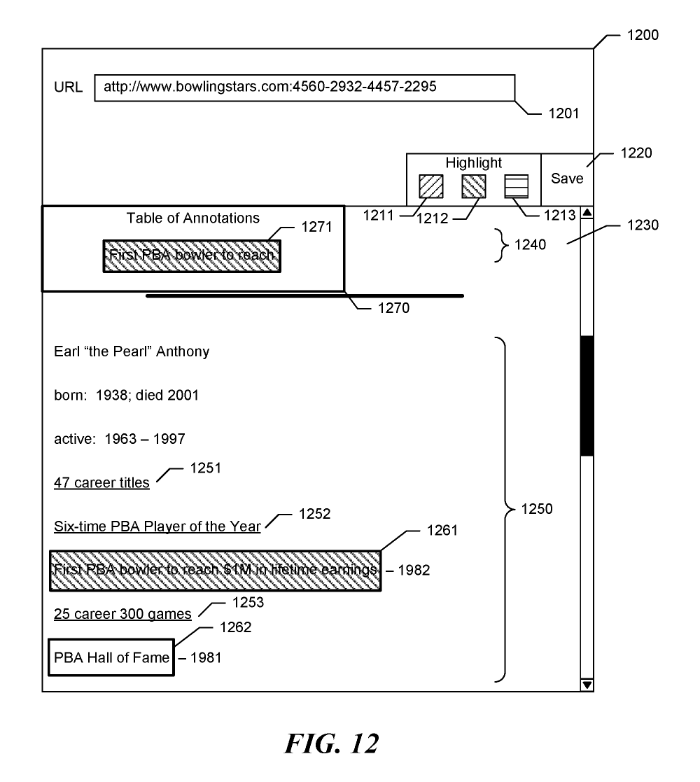

FIG. 12 is a display diagram showing a sample display presented by the facility in some embodiments showing the second user's interactions with the annotated web page. In FIG. 11, the second user clicked on table of annotations thumbnail 1171 to scroll the display of the annotated web page in client area 1230 as shown in FIG. 12, where highlighting annotation 1261 is visible. The second user has further selected text 1262 as a basis for making his or her own highlighting annotation to this portion of the document. After doing so, the second user can activate one of the highlighting controls in order to create a highlighting annotation.

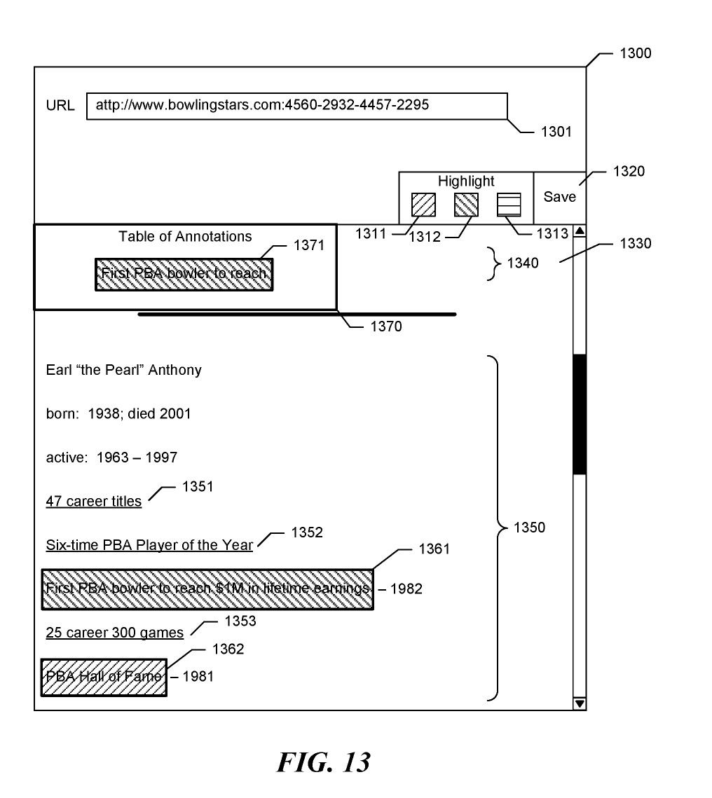

FIG. 13 is a display diagram showing a sample display presented by the facility in some examples to reflect the user's creation of a highlighting annotation. By comparing FIG. 13 to FIG. 12, it can be seen that the user has activated highlighting control 1211 to create a highlighting annotation 1362 from selected text 1262. It can further be seen that the pattern/color of highlighting annotation 1362 matches that of highlighting control 1211-1311. The user can activate save control 1320 in order to make the annotated version of the web page shown in FIG. 13 available to share with one or more other users. When the user does so, the facility at 311 sends an upload request to the annotation server containing the same version of HTML received for the page from the annotation server and a set of highlighting annotation indications that indicate both annotation 1361 and 1362.

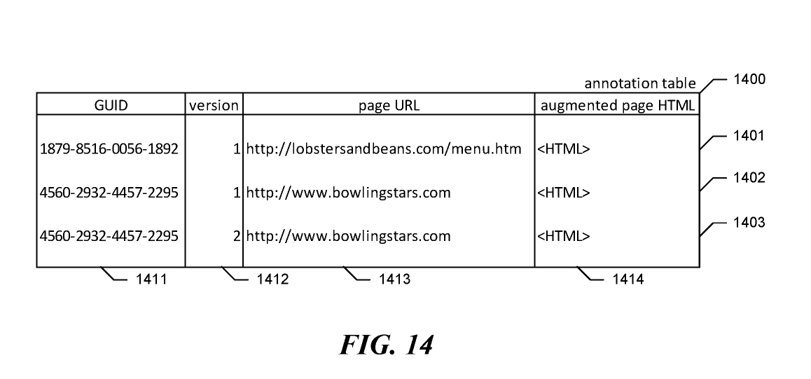

FIG. 14 is a table diagram showing contents of the annotation table updated to reflect the upload request from the second user's web browser. It can be seen that the facility has added entry 1403 to annotation table 1400. Entry 1403 has the same GUID in page URL as entry 1402. Entry 1403 has the version number 2, which is one higher than the highest version number previously present in the annotation table for this GUID. The HTML at the intersection of row 1403 and column 1414 is HTML containing custom tags representing both the highlighting annotation 1361 made by the first user and the highlighting annotation 1362 made by the second user. The annotation server returns an ATTP URL identifying these annotations that contain the version number “2”: “attp://www.bowlingstars.com:4560-2932-4457-2295@2”.

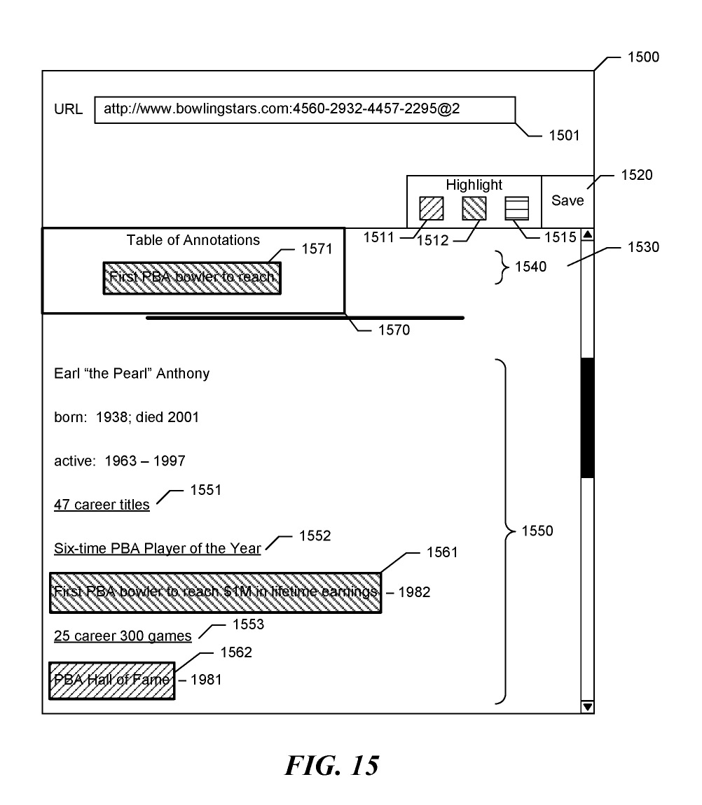

FIG. 15 is a display diagram showing a sample display presented by the facility in some examples to reflect storage of the second user's annotations. It can be seen by comparing FIG. 15 to FIG. 13 that the ATTP URL in URL field 1501 contains an “@2”. This corresponds to the second version in the present thread of annotations to this web page. The second user can proceed to share this new ATTP URL with other users, who can use the new ATTP URL to access a version of the web page containing both the first user's annotations and the second user's annotations.

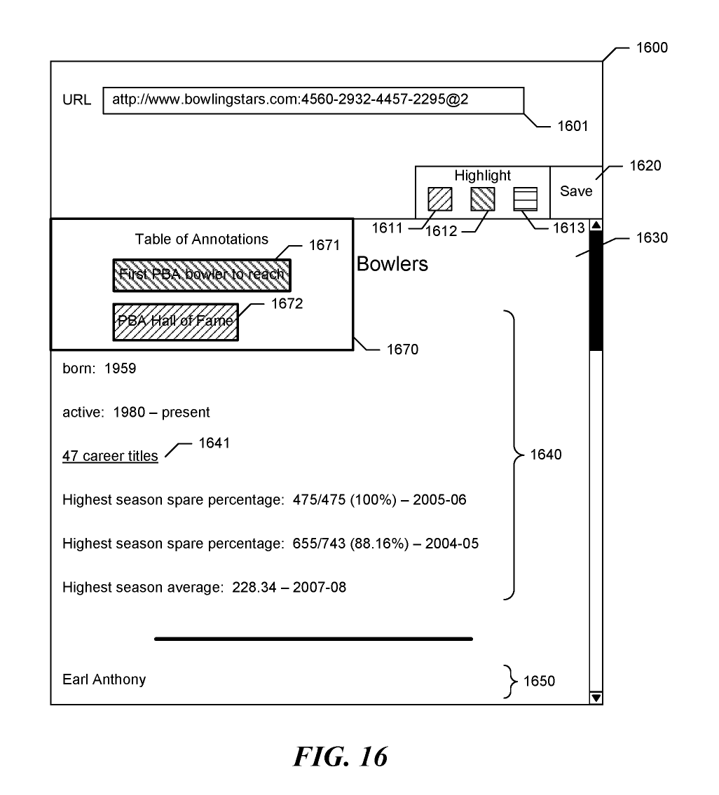

FIG. 16 is a display diagram showing a sample display presented by the facility in some examples when a third user dereferences the second ATTP URL. It can be seen that the display 1500 includes a table of annotations 1570 that contains a thumbnail 1571 corresponding to the first user's highlighting annotation, and a thumbnail 1572 corresponding to the second user's highlighting annotation. The third user can select either of these thumbnails to display the corresponding annotation in the context of the annotated web page.

This annotation process can proceed through any number of iterations, including both new annotating users and repeating annotating users. Furthermore, the user can explicitly request any version of the annotations by specifying the corresponding version number after the “@” in the ATTP URL. Also, a user can begin a separate thread of annotations to the same web page by loading the web page using its HTTP URL, then making and saving one or more annotations.

In some examples, the facility provides a method in a computing system for storing annotations to a web page, comprising: retrieving a tag language representation of the web page from a web server associated with the web page; displaying a rendered version of the retrieved tag language representation of the web page; receiving input from a first user specifying an annotation with respect to a distinguished point in the rendered version of the retrieved tag language representation of the web page; adding at least one custom tag representing the specified annotation to a copy of the retrieved tag language representation of the web page at a point in the copy of the retrieved tag language representation of the web page corresponding to the distinguished point in the rendered version of the retrieved tag language representation of the web page; and storing the copy of the retrieved tag language representation of the web page to which the at least one custom tag was added, in connection with a shareable identifier of the specified annotation.

In some examples, the facility provides one or more instances of computer-readable media collectively having contents configured to cause a computing system to perform a method for storing annotations to a web page, the method comprising: retrieving a tag language representation of the web page from a web server associated with the web page; displaying a rendered version of the retrieved tag language representation of the web page; receiving input from a first user specifying an annotation with respect to a distinguished point in the rendered version of the retrieved tag language representation of the web page; adding at least one custom tag representing the specified annotation to a copy of the retrieved tag language representation of the web page at a point in the copy of the retrieved tag language representation of the web page corresponding to the distinguished point in the rendered version of the retrieved tag language representation of the web page; and storing the copy of the retrieved tag language representation of the web page to which the at least one custom tag was added, in connection with a shareable identifier of the specified annotation.

In some examples, the facility provides a computing system for storing annotations, the computing system comprising: at least one processor; and memory having contents whose execution by the at least one processor causes the computing system to perform a method, the method comprising: retrieving a tag language representation of the web page from a web server associated with the web page; displaying a rendered version of the retrieved tag language representation of the web page; receiving input from a first user specifying an annotation with respect to a distinguished point in the rendered version of the retrieved tag language representation of the web page; adding at least one custom tag representing the specified annotation to a copy of the retrieved tag language representation of the web page at a point in the copy of the retrieved tag language representation of the web page corresponding to the distinguished point in the rendered version of the retrieved tag language representation of the web page; and storing the copy of the retrieved tag language representation of the web page to which the at least one custom tag was added, in connection with a shareable identifier of the specified annotation.

In some examples, the facility provides one or more instances of computer-readable media collectively having contents configured to cause a computing system to perform a method for handling a web page annotation URL scheme, the method comprising: receiving a URL qualified by the web page annotation URL scheme, the web page annotation URL scheme being distinct from the HTTP URL scheme; sending at least a portion of the received URL to an annotation server in an annotation server domain, neither the annotation server nor the annotation server domain being identified in the received URL; receiving from the annotation server source for a web page incorporating one or more user annotations; and using a browser to display, from the received source, a rendered version of the web page incorporating the user annotations.

In some examples, the facility provides a method in a computing system for handling a web page annotation URL scheme, comprising: receiving a URL qualified by the web page annotation URL scheme, the web page annotation URL scheme being distinct from the HTTP URL scheme; sending at least a portion of the received URL to an annotation server in an annotation server domain, neither the annotation server nor the annotation server domain being identified in the received URL; receiving from the annotation server source for a web page incorporating one or more user annotations; and using a browser to display, from the received source, a rendered version of the web page incorporating the user annotations.

In some examples, the facility provides a computing system for handling a web page annotation URL scheme, the computing system comprising: at least one processor; and memory having contents whose execution by the at least one processor causes the computing system to perform a method, the method comprising: receiving a URL qualified by the web page annotation URL scheme, the web page annotation URL scheme being distinct from the HTTP URL scheme; sending at least a portion of the received URL to an annotation server in an annotation server domain, neither the annotation server nor the annotation server domain being identified in the received URL; receiving from the annotation server source for a web page incorporating one or more user annotations; and using a browser to display, from the received source, a rendered version of the web page incorporating the user annotations.

In some examples, the facility provides a computing system for providing a web page annotation user interface, the computing system comprising: at least one processor; and memory having contents whose execution by the at least one processor causes the computing system to perform a method, the method comprising: receiving source for a subject web page, the source specifying both visual content of the subject web page, and a traversable link to an additional web page; displaying a rendered version of the received source for the subject web page; receiving first user input specifying an annotation to the subject web page and a distinguished point in the displayed rendered version of the received source for the subject web page; after receiving the first user input, receiving second user input traversing the link to the additional web page; and in response to receiving the second user input: receiving source for the additional web page; and displaying a rendered version of the received source for the additional web page.

In some examples, the facility provides a method in a computing system for providing a web page annotation user interface, comprising: receiving source for a subject web page, the source specifying both visual content of the subject web page, and a traversable link to an additional web page; displaying a rendered version of the received source for the subject web page; receiving first user input specifying an annotation to the subject web page and a distinguished point in the displayed rendered version of the received source for the subject web page; after receiving the first user input, receiving second user input traversing the link to the additional web page; and in response to receiving the second user input: receiving source for the additional web page; and displaying a rendered version of the received source for the additional web page.

In some examples, the facility provides one or more instances of computer-readable media collectively having contents configured to cause a computing system to perform a method for providing a web page annotation user interface, the method comprising: receiving source for a subject web page, the source specifying both visual content of the subject web page, and a traversable link to an additional web page; displaying a rendered version of the received source for the subject web page; receiving first user input specifying an annotation to the subject web page and a distinguished point in the displayed rendered version of the received source for the subject web page; after receiving the first user input, receiving second user input traversing the link to the additional web page; and in response to receiving the second user input: receiving source for the additional web page; and displaying a rendered version of the received source for the additional web page.

In some examples, the facility provides one or more memories collectively storing an annotation table data structure, the data structure comprising: a plurality of entries each representing a set of annotations performed with respect to a web page, each entry comprising: first information uniquely identifying the set of annotations; and a copy of the web page with respect to which the set of annotations was performed, retrieved from a web server of the web page at a time before any of the annotations of the set of annotations was performed, the copy of the web page having been modified to incorporate each of the annotations of the set of annotations, such that the contents of the data structure can be used to return and display a copy of a web page having a particular set of annotations based upon information uniquely identifying the set of annotations.

It will be appreciated by those skilled in the art that the above-described facility may be straightforwardly adapted or extended in various ways. While the foregoing description makes reference to particular embodiments, the scope of the invention is defined solely by the claims that follow and the elements recited therein.

We claim:

1. A method in a computing system for storing annotations to a web page, comprising:
retrieving a tag language representation of the web page from a web server associated with the web page;
displaying a rendered version of the retrieved tag language representation of the web page;
receiving input from a first user specifying an annotation with respect to a distinguished point in the rendered version of the retrieved tag language representation of the web page;
adding at least one custom tag representing the specified annotation to a copy of the retrieved tag language representation of the web page at a point in the copy of the retrieved tag language representation of the web page corresponding to the distinguished point in the rendered version of the retrieved tag language representation of the web page; and
storing the copy of the retrieved tag language representation of the web page to which the at least one custom tag was added, in connection with a shareable identifier of the specified annotation.

2. The method of claim 1 wherein the rendered version of the retrieved tag language representation of the web page contains a sequence of visible textual characters,
and wherein the specified annotation is a selection of a subrange of the sequence of visible textual characters for display against a background color not specified by the retrieved tag language representation of the web page.

3. The method claim 1 wherein the storing stores the copy of the retrieved tag language representation of the web page to which the at least one custom tag was added on a server from which it can be retrieved on behalf of any user providing the shareable identifier.

4. The method claim 1, further comprising:
before storing the copy of the retrieved tag language representation of the web page to which the at least one custom tag was added:
identifying in the retrieved tag language representation of the web page in incorporation reference for an external resource;
using incorporation reference to retrieve the external resource; and
in the retrieved tag language representation of the web page, replacing the identified incorporation reference with the retrieved external resource.

5. The method of claim 1, further comprising:
before storing the copy of the retrieved tag language representation of the web page to which the at least one custom tag was added:
for each of one or more tags occurring in the retrieved tag language representation of the web page:
adding to the tag an attribute whose value is a globally-unique identifier that can be used to identify the tag as corresponding to the distinguished point in the rendered version of the retrieved tag language representation of the web page.

6. The method of claim 5, further comprising:
storing a representation of the specified annotation in which the distinguished point in the rendered version of the retrieved tag language representation of the web page with respect to which the annotation was specified as identified based upon a globally-unique identifier added as an attribute value to a distinguished tag occurring in the retrieved tag language representation of the web page.

7. The method of claim 6, wherein the distinguished tag encloses a text string made up of characters,
and wherein the stored representation of the specified annotation identifies a range of characters within the enclosed text string with respect to which the annotation was specified.

8. The method of claim 6, further comprising generating the representation that is stored in JSON.

9. The method of claim 1, further comprising:
retrieving the stored copy; and
displaying a rendered version of the stored copy in which the specified annotation is incorporated for review by a second user distinct from the first user.

10. One or more instances of computer-readable media collectively having contents configured to cause a computing system to perform a method for handling a web page annotation URL scheme, the method comprising:
receiving a URL qualified by the web page annotation URL scheme, the web page annotation URL scheme being distinct from the HTTP URL scheme;
sending at least a portion of the received URL to an annotation server in an annotation server domain, neither the annotation server nor the annotation server domain being identified in the received URL;
receiving from the annotation server source for a web page incorporating one or more user annotations; and
using a browser to display, from the received source, a rendered version of the web page incorporating the user annotations.

11. The one or more instances of computer-readable media of claim 10 wherein source for the web page was retrieved from a web server for the web page in a web server domain, the web server domain being distinct from the annotation server domain,
and wherein the received URL contains the web server domain.

12. The one or more instances of computer-readable media of claim 10 wherein source for the web page was retrieved from a web server using an HTTP URL,
and wherein the received URL contains the portion of the HTTP URL that follows the HTTP URL scheme.

13. The one or more instances of computer-readable media of claim 10 wherein the received URL contains an identifier for a thread of user annotations that includes the incorporated user annotations.

14. The one or more instances of computer-readable media of claim 13 wherein the received URL further contains an identifier for an annotation version among the thread of user annotations.

15. The one or more instances of computer-readable media of claim 14 wherein the identifier for the annotation version is a whole number.

16. A computing system for providing a web page annotation user interface, the computing system comprising:
at least one processor; and
memory having contents whose execution by the at least one processor causes the computing system to perform a method, the method comprising:
receiving source for a subject web page, the source specifying both visual content of the subject web page, and a traversable link to an additional web page;
displaying a rendered version of the received source for the subject web page;
receiving first user input specifying an annotation to the subject web page and a distinguished point in the displayed rendered version of the received source for the subject web page;
after receiving the first user input, receiving second user input traversing the link to the additional web page; and
in response to receiving the second user input:
receiving source for the additional web page; and
displaying a rendered version of the received source for the additional web page.

17. The computing system of claim 16 wherein the received first user input specifies an annotation that identifies text among the visual content specified for the subject web page.

18. The computing system of claim 17, the method further comprising, between receiving the first user input and receiving the second user input:
displaying the text identified by the annotation against a background of a distinguished color against which no text among the visual content specified for the subject web page that is not identified by the annotation is displayed.

19. The computing system of claim 16, the method further comprising:
before receiving the first user input, displaying a first URL having the HTTP URL scheme; and
after receiving the first user input, replacing the displayed first URL the second URL not having the HTTP URL scheme.

20. The computing system of claim 16, the method further comprising:
after receiving the first user input:
displaying a visual indication of the specified annotation;
receiving third user input selecting the displayed visual indication of the specified annotation; and
in response to receiving the third user input, causing the displayed rendered version of the received source for the subject web page to be scrolled to visually feature the distinguished point in the displayed rendered version of the received source for the subject web page.
